(19) United States
(12) Patent Application Publication
(10) Pub. No.: US 2010/0031786 A1
(43) Pub. Date: Feb. 11, 2010

(54) DISPENSING MATERIAL FOR APPLICATIONS

(76) Inventor: Keng Nye KAO, Singapore (SG)

Correspondence Address: HORIZON IP PTE LTD, 7500A Beach Road, #04-306/308 The Plaza, SINGAPORE 199591, SG

(21) Appl. No.: 12/508,605

(22) Filed: Jul. 24, 2009

Related U.S. Application Data
(60) Provisional application No. 61/083,579, filed on Jul. 25, 2008.

(51) Int. Cl. B25B 7/02

(52) U.S. Cl. 81/426.5; 81/418

(57) ABSTRACT

A device to facilitate dispensing of material is presented. The device includes a gripping portion that includes handles for user to hold the device and a holding portion. The holding portion includes jaws when meeting together form openings with varying diameters to hold probes of different sizes.

### BACKGROUND

Cryogenic materials are very cold substances that are used in a wide variety of processes and treatment. By definition, cryogenic liquids have boiling points below minus 90° C. For example, liquid nitrogen at −196° C., liquid helium at −269° C., liquid argon at −186° C. and liquid methane at −161° C., etc. Hence, before handling cryogenic materials, personal protection, such as cryo-gloves, cryo-apron, safety goggles and shoes must be used.

Cryogenic materials are often employed for applications such as freezing, cooling, flushing, and purging of machines/equipment. Other applications include deep freezing of biological organs, cryo-ablation of cancerous cells or tumor, targeted cryo-ablation of prostate enlargement and warts, and medical application or preservation of viruses, bacteria, microorganisms, DNA, etc.

As the cryogenic materials are often stored in bulk storage tank, such as an intermediate vessel or container, there is a frequent need to transfer smaller amounts of the cryogenic materials into various smaller double-walled vacuum-sealed containers, like the Dewar flasks, cryo-vessel or indirectly onto the cancerous tumor, wart or prostate. These handling operations are carried out in environments, such as laboratory, process room, for organs, sperms, and other specimens in frozen storage rooms, or in hospital clinics and surgery operation rooms.

Owing to its volatile nature, safety considerations during the transferring and handling of the cryogenic materials are of great concern. For example, over pressurization or rupture of the Dewar flasks, columns, or cryogenic equipment can occur during the filling, the phase change from liquid to gas, or the accidental mixing with water (such as rain water) in the Dewar flask resulting in rupture of the equipment. All cryogenic materials produce large volumes of gas when the liquid is raised to ambient temperature and vaporizes. Excessive vapor and hazards may also be produced during the process of transferring, such as air bubbling, overfilling and splashing, especially in an enclosed environment when the cryogenic material is discharged.

In view of the foregoing, it is desirable to provide devices for safe handling and transfer of cryogenic materials from bulk storage to smaller containers. Furthermore, it is desirable to provide a medical device for cryogenic medical applications.

### SUMMARY

A device to facilitate dispensing of material is presented. The device includes a gripping portion that includes handles for user to hold the device and a holding portion. The holding portion includes jaws when meeting together form openings with varying diameters to hold probes of different sizes.

In another embodiment, a device for dispensing material that includes a tube with first and second ends is disclosed. The device further includes a nozzle head comprising at least one orifice that is coupled to the first end of the tube and a coupling member for coupling the tube to a supply source.

These and other objects, along with advantages and features of the present invention herein disclosed, will become apparent through reference to the following description and the accompanying drawings. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows an embodiment of a device;

FIGS. 2a-d show various embodiments of devices;

FIGS. 3a-b show an embodiment of a holder for devices;

FIGS. 4a-b show another embodiment of a holder for devices; and

FIGS. 5a-b show another embodiment of a holder for devices.

### DETAILED DESCRIPTION

Cryogenic materials include, for example, liquid nitrogen, liquid helium, liquid argon or liquid methane. Other types of materials, such as non-cryogenic materials, can also be useful. Cryogenic materials can be used in medical applications. For example, devices can be used to dispense cryogenic material (liquid or vapor) to blast over the cancerous cell or growth, prostrate or warts in order to permanently stop its growth. Embodiments relate generally to devices for safe handling and dispensing of cryogenic materials for, for example, medical applications.

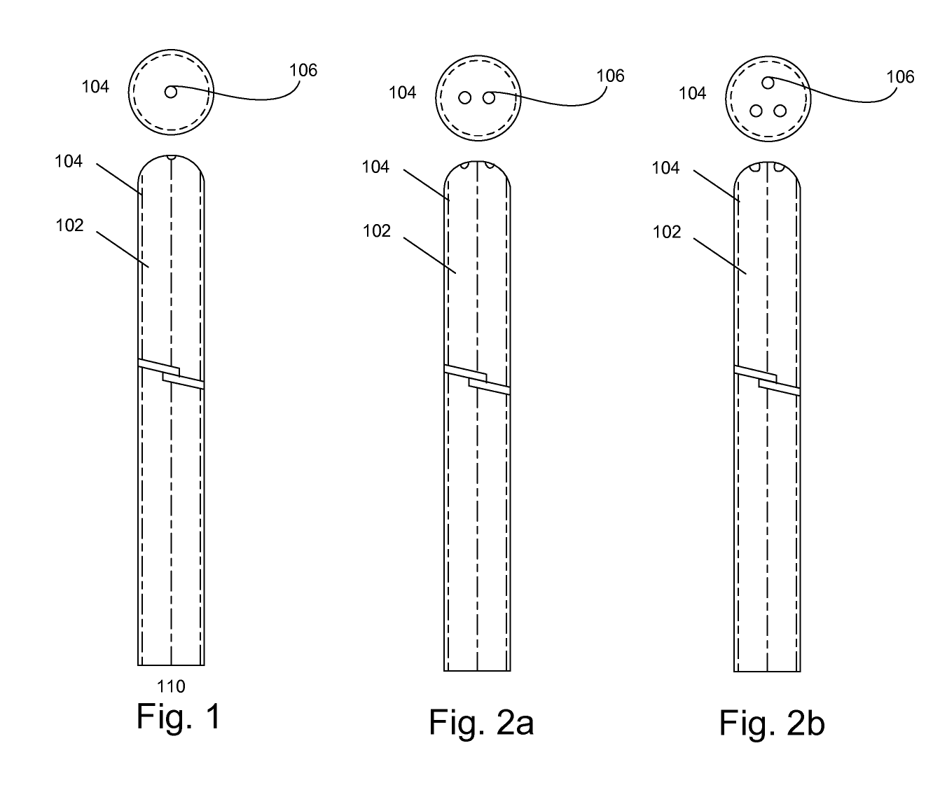

FIG. 1 shows a device 110 for dispensing, for example, cryogenic materials. In one embodiment, the device comprises a target probe device for medical applications. The probe can also be used to dispense other types of material or for other types of applications. The probe can be used in, for example, a surgical procedure to remove cancerous tumors or unwanted growth by ablating it with extremely cold cryogenic material. In one embodiment, the probe 110 comprises a probe tube 102 with first and second ends. A nozzle head 104 is provided at the first end. The second end of the probe tube comprises a coupling for coupling to a supply source. The supply source, in one embodiment, supplies cryogenic material to the probe. A pressure gauge can be provided to indicate existing pressure of the supply source.

In one embodiment, the probe tube comprises a flexible tubing. The flexible tubing, for example, comprises a very low temperature resistant plastic, such as Teflon, polyurethane, or polypropylene. The flexible tubing, alternatively, must be made from materials such as a pure grade stainless steel, carbon steel, titanium alloy, aluminium alloy, copper alloy, zinc alloy, nickel alloy, etc. Other types of materials, such as those which suitable for very low temperature applications, are also useful.

The length of the probe tube depends on the type of application. The probe can be used for various types of applications. For example, in an invasive open surgery operation, such as freezing or destroying a cancerous growth, wart or prostate on a patient's body, the length is sufficient to allow the nozzle head to be inserted into the body cavity and pushed directly against the desired site. For a minimally invasive procedure, the probe tube is preferably long enough to allow the nozzle head to be inserted through the patient's esophagus or intestines so as to reach the desired site. Other types of applications are also useful.

The nozzle head 104 is coupled to the probe tube 102. The nozzle head can be coupled to the probe tube using various techniques. For example, the nozzle can be screwed in, welded or molded onto the flexible stainless steel, aluminum alloy tubing or a soft metallic tubing with the orifices being drilled, welded, molded, or lathed. Other techniques for coupling the nozzle head to the probe tube are also useful.

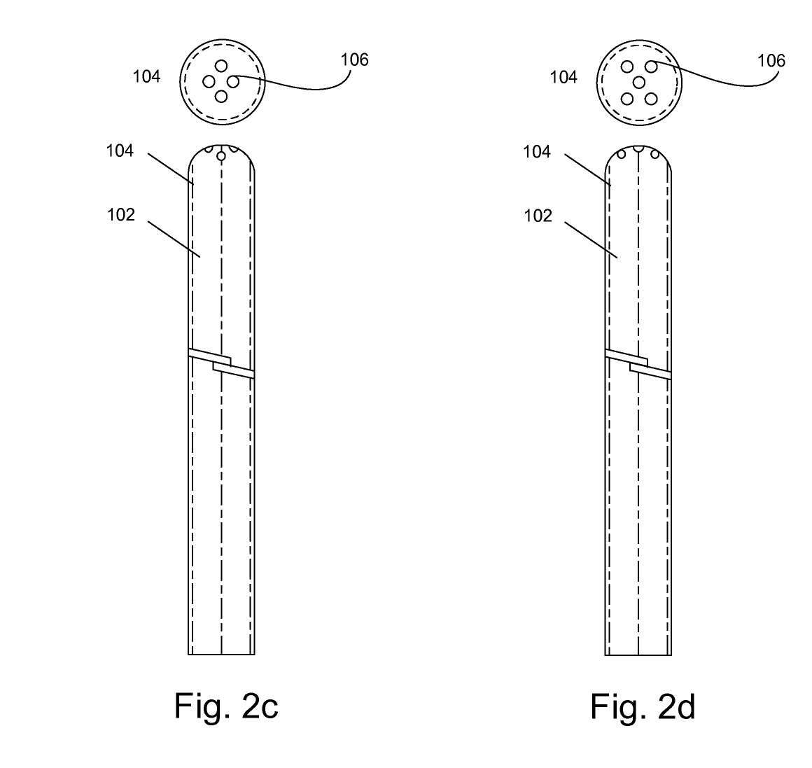

In one embodiment, the nozzle head comprises at least one orifice 106. Other numbers of orifices and arrangements are also useful. For example, FIGS. 2a-d show nozzle head with other number and arrangements of orifices 106. The diameter of an orifice can range from about 1 mm to about 5 mm. Other diameters are also useful. The size and/or number of orifices can depend on the applications. For example, the number or dimensions of the orifices may be reduced or increased, depending on the application.

In one embodiment, cryogenic material flowing from the container is regulated by a triggering device (not shown) coupled to the probe tube. The triggering device can be a hand-held device to allow the surgeon to conveniently control the flow of the cryogenic material during surgery. The triggering device is coupled to the probe tube 102. In one embodiment, the triggering device uses compressed air to force cryogenic material out through the nozzle head 106 upon actuation. The triggering device can be actuated by, for example, using a finger to push a spring-loaded mechanism. Other types of actuators are also useful.

In another embodiment, cryogenic material is dripped onto the desired site using gravity flow or siphoning. The amount of cryogenic material in the container is monitored by the user while applying it. Other methods of application, such as pumping or air-driving, are also useful.

In yet another embodiment, the cryogenic material is atomized prior to application onto the desired site. This can be achieved by, for example, ultrasonic atomizers or air atomizers. The ultrasonic atomizer, in one embodiment, comprises an air driven acoustic oscillator that atomizes liquids by passing them through a field of high frequency sound waves, thereby producing very fine droplets. The air atomizer conveniently incorporates feed lines for air and cryogenic material such that contact between air flow and cryogenic material produces a cold mist spray. The air atomizer can include other optional devices, such as air-operated cylinders for remote control. Other types of atomizers are also useful.

In one embodiment, ultrasonic atomization is achieved by a two-step process. First, cryogenic material is ejected through one or more orifices of the nozzle head 104, into a spray nozzle outlet orifice. At the spray nozzle outlet orifice, a high velocity air stream produces a first break-up of the cryogenic material via a shearing action, resulting in droplets containing the cryogenic material. Next, the air stream carrying the droplets is subjected to impact through a field of high frequency sound waves produced by a resonator placed in front of the spray nozzle outlet orifice. The droplets being subjected to the impact are vigorously shattered into substantially finer droplets, hence producing atomized droplets. Having produced the atomized droplets, air bypassing the resonator carries the atomized droplets as a soft, low velocity spray.

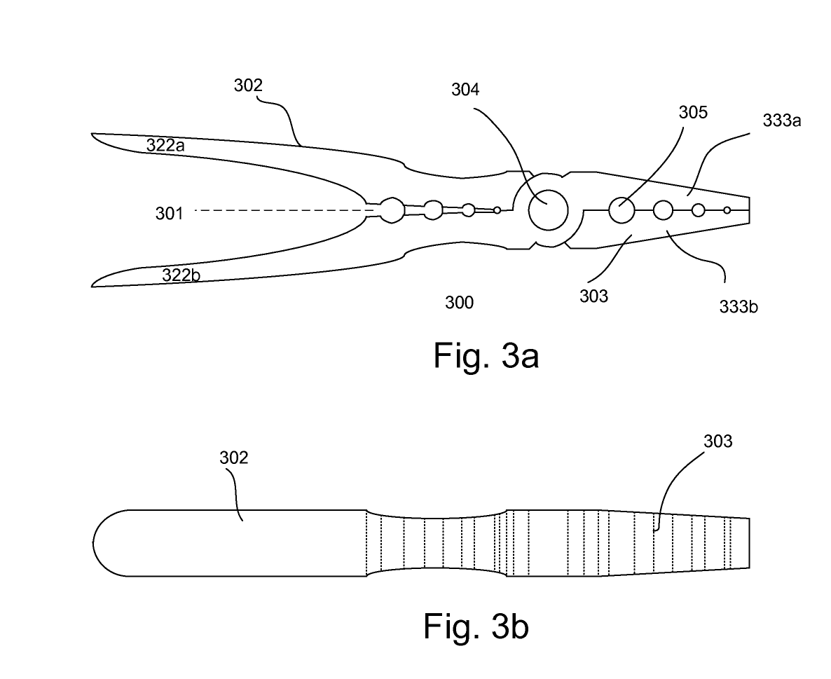

FIGS. 3a and 3b show top and side views of an embodiment of a probe holder 300. The probe holder facilitates placing the tip of the target probe at a desired location, such as on the specific cancerous location. The probe holder can be formed from stainless steel, carbon steel, steel alloy, or metallic alloy with powder coat. Other materials are also useful.

In one embodiment, the probe holder comprises substantially symmetrical members which can rotate about a centre axis 301. The members include gripping portions 302 and holding portions 303. The gripping portions comprise, in one embodiment, handles 322a-b for the user to hold or grip the device. Other forms of gripping mechanisms are also useful. The holding portions 303 comprise, in one embodiment, jaws 333a-b for holding the nozzle head. Other types of holding mechanisms are also useful. The dimensions of the holder depend on the type of application. In one embodiment, the holder height H is of about 1 to about 6 cm and the length L is of about 10 to about 16 cm. Any other suitable dimensions are also useful.

The handles, when compressed towards or expanded away from each another, cause jaws of the holder to rotate about a pivot 304 such that the jaws may move towards or away with respect to one another. Jaws, when meeting together about the centre axis 301, forms third grip openings 305 having varying diameters, shapes and sizes. In one embodiment, the grip openings may be of varying diameters arranged in various orders. The openings, for example, range from about 1 to 5 mm. Providing various grip openings enables the grip holder to be used with different sized probes. When the handles are compressed toward each other, the jaws should exert sufficient pressure to secure the probe.

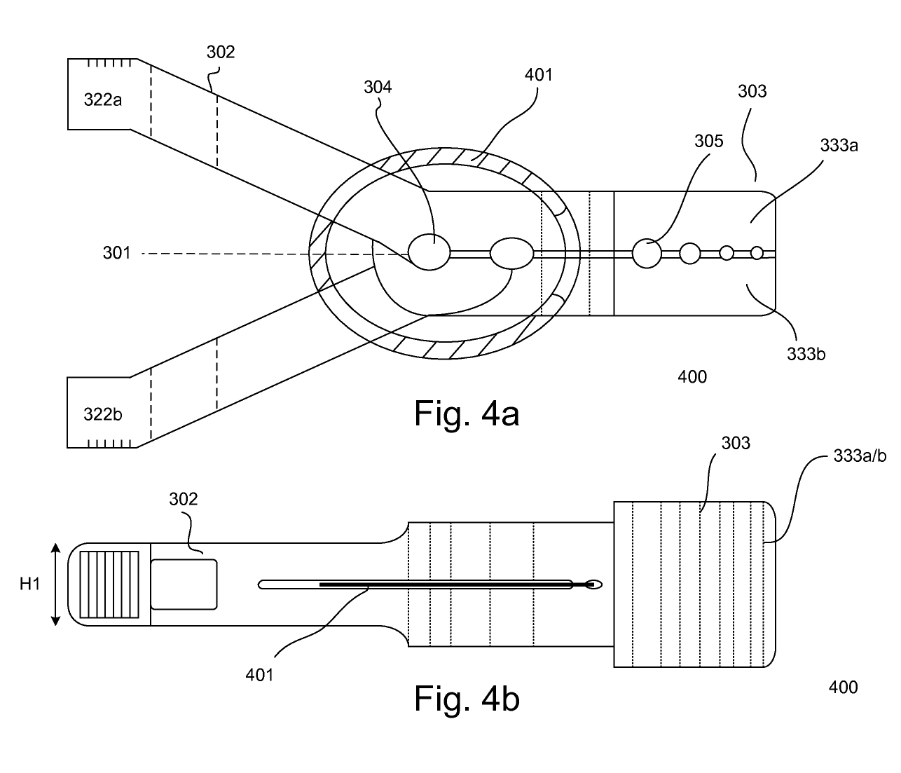

FIGS. 4a and 4b show top and side views of another embodiment of a probe holder 400. The holder 400 further comprises a hold stabilizer 401. The hold stabilizer, facilitate easy operation of the holder. The hold stabilizer, for example, comprises a retractable or spring loaded mechanism, such as a spring clip or a tension ring. Other types of mechanisms to assist holding, such as compressed-fluid mechanisms, are also useful.

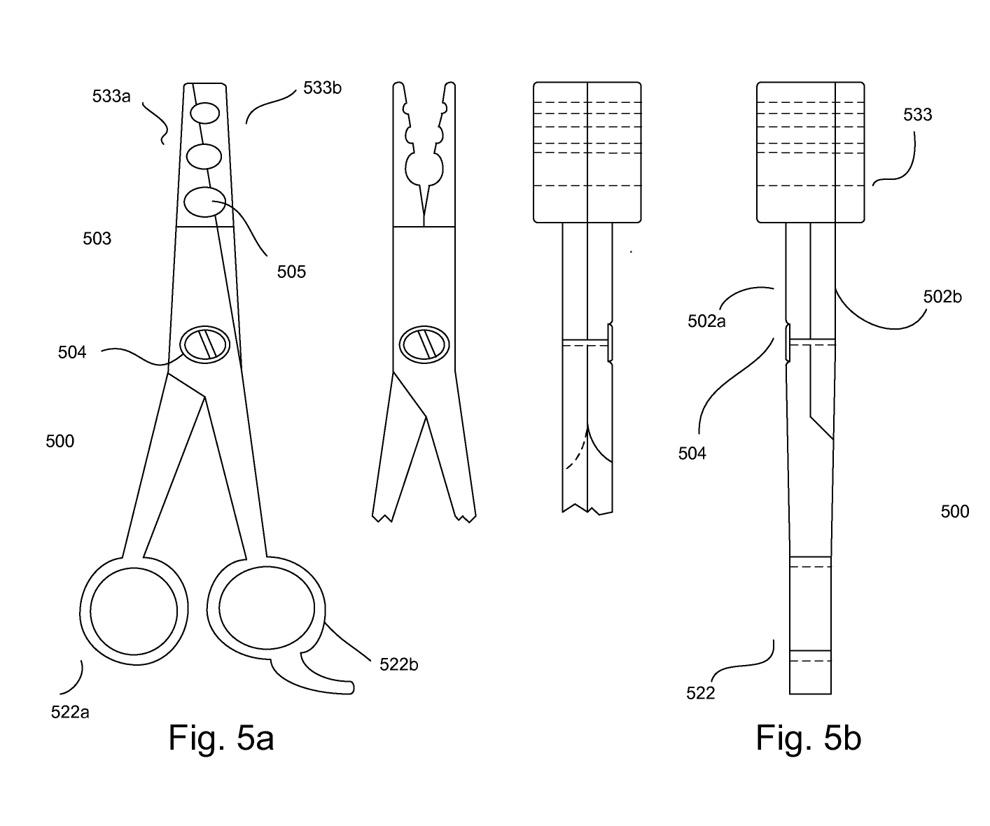

FIGS. 5a and 5b show top and side views of an embodiment of a probe holder 500. In one embodiment, the probe holder comprises substantially symmetrical members 502a-b which can rotate about a centre axis. The members include gripping portions and holding portions. The gripping portions comprise, in one embodiment, handles 522a-b for the user to hold or grip the device. The handles, for example, include rings, similar to those of scissors. Other forms of gripping mechanisms are also useful. The holding portions 503 comprise, in one embodiment, jaws 533a-b for holding the nozzle head. Other types of holding mechanisms are also useful.

The handles, when compressed towards or away from one another, cause jaws of the holder to rotate about pivot 504 such that the jaws may move towards or away with respect to one another. Jaws, when meeting together about the centre axis, forms third grip openings 505 having varying diameters, shapes and sizes. As shown, openings are arranged with the smallest at the end of the jaws and increasing in size toward the beginning of the jaws. Alternatively, the openings can be arranged with the largest at the end of the jaws and decreasing in size towards the beginning of the jaws. When the handles are compressed toward each other, the jaws should exert sufficient pressure to secure the probe.

The invention may be embodied in other specific forms without departing from the spirit or essential characteristics thereof. The foregoing embodiments, therefore, are to be considered in all respects illustrative rather than limiting the invention described herein. Scope of the invention is thus indicated by the appended claims, rather than by the foregoing description, and all changes that come within the meaning and range of equivalency of the claims are intended to be embraced therein.

What is claimed is:

1. A device to facilitate dispensing of material comprising:
a gripping portion comprising handles for user to hold the device; and
a holding portion,
wherein the holding portion comprises jaws when meeting together form openings with varying diameters to hold probes of different sizes.

2. The device of claim 1 wherein the device is used for dispensing cryogenic material.

3. The device of claim 1 further comprises a hold stabilizer.

4. The device of claim 3 wherein the hold stabilizer comprises a spring loaded mechanism.

5. A device for dispensing material comprising:
a tube with first and second ends;
a nozzle head comprising at least one orifice is coupled to the first end of the tube; and
a coupling member for coupling the second end of the tube to a supply source.

6. The device of claim 5 wherein the nozzle head comprises a plurality of orifices of different size.

7. The device of claim 5 wherein the tube comprises flexible tubing.

8. The device of claim 7 wherein the flexible tubing comprises low temperature resistant plastic.

9. The device of claim 8 wherein the low temperature resistant plastic comprises Teflon, polyurethane or polypropylene.

10. The device of claim 7 wherein the flexible tubing is made of material comprising stainless steel, carbon steel, titanium alloy, aluminum alloy, copper alloy, zinc alloy or nickel alloy.
